(19) United States
(12) Patent Application Publication
(10) Pub. No.: US 2017/0070731 A1
(43) Pub. Date: Mar. 9, 2017

(54) Single And Multi-Camera Calibration

(71) Applicant: Apple Inc., Cupertino, CA (US)

(72) Inventors: Benjamin A. Darling, Cupertino, CA (US); Thomas E. Bishop, San Francisco, CA (US); Kevin A. Gross, San Francisco, CA (US); Paul M. Hubel, Mountain View, CA (US); Todd S. Sachs, Palo Alto, CA (US); Guangzhi Cao, Cupertino, CA (US); Alexander Lindskog, Santa Clara, CA (US); Stefan Weber, Cupertino, CA (US); Jianping Zhou, Fremont, CA (US)

(21) Appl. No.: 15/256,526

(22) Filed: Sep. 3, 2016

Related U.S. Application Data
(60) Provisional application No. 62/347,935, filed on Jun. 9, 2016.
(60) Provisional application No. 62/214,711, filed on Sep. 4, 2015.

(51) Int. Cl. H04N 17/00; G06T 7/00

(52) U.S. Cl. CPC H04N 17/002; G06T 7/0018; G06T 7/002; G06T 7/003

(57) ABSTRACT

Camera calibration includes capturing a first image of an object by a first camera, determining spatial parameters between the first camera and the object using the first image, obtaining a first estimate for an optical center, iteratively calculating a best set of optical characteristics and test setup parameters based on the first estimate for the optical center until the difference in a most recent calculated set of optical characteristics and previously calculated set of optical characteristics satisfies a predetermined threshold, and calibrating the first camera based on the best set of optical characteristics. Multi-camera system calibration may include calibrating, based on a detected misalignment of features in multiple images, the multi-camera system using a context of the multi-camera system and one or more prior stored contexts.

### BACKGROUND

This disclosure relates generally to the field of digital image capture and processing, and more particularly to the field of single and multi-camera calibration.

The geometric calibration of a multiple camera imaging system is used to determine corresponding pixel locations between a reference camera and a secondary camera based on estimated intrinsic properties of the cameras and their extrinsic alignment. For many computer vision applications, the essential parameters of a camera need to be estimated. Depending on the application, the accuracy and precision of the estimation may need to be somewhat strict. For example certain applications require extremely accurate estimation, and errors in the estimation may deem the applications unusable. Some examples of applications that rely on strict camera calibration include stereo imaging, depth estimation, artificial bokeh, multi-camera image fusion, and special geometry measurements.

Current methods for calibrating multiple cameras require finding solutions in high dimensional spaces, including solving for the parameters of high dimensional polynomials in addition to the parameters of multiple homographies and extrinsic transformations in order to take into consideration all the geometric features of every camera. Some methods for calibrating multiple cameras require each camera obtaining multiple images of an object, which can be inefficient.

### SUMMARY

In one embodiment, a method for camera calibration is described. The method may include capturing a first image of an object by a first camera, determining spatial parameters between the first camera and the object using the first image, obtaining a first estimate for an optical center, iteratively calculating a best set of optical characteristics and test setup parameters based on the first estimate for the optical center until the difference in a most recent calculated set of optical characteristics and previously calculated set of optical characteristics satisfies a predetermined threshold, and calibrating the first camera based on the best set of optical characteristics.

In another embodiment, a method for multi-camera calibration is described. The method includes obtaining a frame captured in by a multi-camera system, detecting one or more feature points in the frame, matching descriptors for the feature points in the frame to identify corresponding features, in response to determining that the corresponding features are misaligned, optimizing calibration parameters for the multi-camera system to obtain adjusted calibration parameters, storing, in a calibration store, an indication of the adjusted calibration parameters as associated with context data for the multi-camera system at the time the frame was captured, and calibrating the multi-camera system based, at least in part, on the stored indication of the adjusted calibration parameters.

In another embodiment, the various methods may be embodied in computer executable program code and stored in a non-transitory storage device. In yet another embodiment, the method may be implemented in an electronic device having image capture capabilities.

### BRIEF DESCRIPTION OF THE DRAWINGS

FIG. 1 shows, in block diagram form, a simplified camera system according to one or more embodiments.

FIG. 2 shows, in block diagram form, an example multi camera system for camera calibration.

FIG. 3 shows, flow chart form, a camera calibration method in accordance with one or more embodiments.

FIG. 4 shows, in flow chart form, an example method of estimating optical characteristics of a camera system.

FIG. 5 shows, in flow chart form, an example method of multi-camera calibration.

FIG. 6 shows, in block diagram form, an example multi camera system for camera calibration.

FIG. 7 shows, flow chart form, a multi-camera calibration method in accordance with one or more embodiments.

FIG. 8 shows, flow chart form, a multi-camera calibration method in accordance with one or more embodiments.

FIG. 9 shows, in block diagram form, a simplified multifunctional device according to one or more embodiments.

### DETAILED DESCRIPTION

This disclosure pertains to systems, methods, and computer readable media for camera calibration. In general, techniques are disclosed for concurrently estimating test setup parameters and optical characteristics for a lens of a camera capturing an image. In one or more embodiments, the determination may begin with an initial guess of an optical center for the lens, and/or initial test setup parameters. A best set of optical characteristics and test setup parameters are iteratively or directly calculated until the parameters are determined to be sufficiently accurate. In one embodiment, the parameters may be determined to be sufficiently accurate based on a difference between two sets of parameters. In one or more embodiments, the optical center may then be calculated based on the determined test setup parameters and optical characteristics. That is, in determining a best guess of an optical center, best guesses of optical characteristics of the camera and test setup parameters may additionally be calculated. In doing so, many of the essential parameters of a camera may be estimated with great accuracy and precision in a way that is computationally fast and experimentally practical. Further, calibration between two cameras may be enhanced by utilizing knowledge of best guesses of the test setup parameters. That is, in calculating a best guess of an optical center, knowledge is gained about the exact parameters of a known test setup.

In one or more embodiments, the determined optical characteristics and test setup parameters may then be used to rapidly calibrate a multi-camera system. In one or more embodiments, the determined sufficiently accurate test setup parameters may be used to, along with determined relative spatial parameters between the first camera and a second camera, or multiple other cameras, in calibrating multiple cameras obtaining an image of the same object. Thus, better knowledge of the test setup may be utilized to determine an optical center of a second camera using the same known test setup. Further, the determined test setup parameters from a first camera may be utilized to determine how the first and a second, or additional cameras should be calibrated to each other.

In one or more embodiments, extrinsic and intrinsic parameters of a multi-camera system may need to be occasionally recalibrated. For example, using an autofocus camera, the intrinsic parameters will be recalibrated every time due to the change in focal length of the lens. In one or more embodiments, the cameras in the multi-camera system may need to be recalibrated after a de-calibration event, such as a device being dropped, or any other event that might impair calibrations of one or more of the cameras in the multi-camera system.

In one or more embodiments, the multi-camera system may be dynamically recalibrated over time using images captured naturally by the user. That is, in one or more embodiments, recalibration may occur without capturing an image of a known object. Rather, over time, data may be stored regarding how various parameters are adjusted during calibration of the multi-camera system such that recalibration may rely on historic calibration data.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

For purposes of this disclosure, the term “lens” refers to a lens assembly, which could include multiple lenses. In one or more embodiments, the lens may be moved to various positions to capture images at multiple depths and, as a result, multiple points of focus. Further in one or more embodiments, the lens may refer to any kind of lens, such as a telescopic lens or a wide angle lens. As such, the term lens can mean a single optical element or multiple elements configured into a stack or other arrangement.

For purposes of this disclosure, the term “camera” refers to a single lens assembly along with the sensor element and other circuitry utilized to capture an image. For purposes of this disclosure, two or more cameras may share a single sensor element and other circuitry, but include two different lens assemblies. However, in one or more embodiments, two or more cameras may include separate lens assemblies as well as separate sensor elements and circuitry.

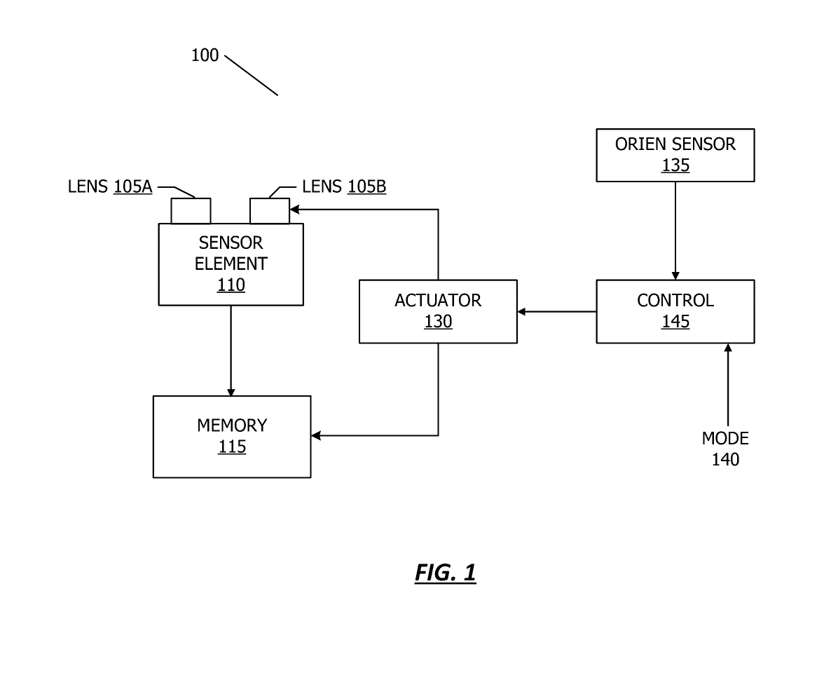

Referring to FIG. 1, a simplified block diagram of camera system 100 is depicted, in accordance with one or more embodiments of the disclosure. Camera system 100 may be part of a camera, such as a digital camera. Camera system 100 may also be part of a multifunctional device, such as a mobile phone, tablet computer, personal digital assistant, portable music/video player, or any other electronic device that includes a camera system.

Camera system 100 may include one or more lenses 105. More specifically, as described above, lenses 105A and 105B may actually each include a lens assembly, which may include a number of optical lenses, each with various lens characteristics. For example, each lens may include its own physical imperfections that impact the quality of an image captured by the particular lens. When multiple lenses are combined, for example in the case of a compound lens, the various physical characteristics of the lenses may impact the characteristics of images captured through the lens assembly, such as focal points. In addition, each of lenses 105A and 105B may have similar characteristics, or may have different characteristics, such as a different depth of focus.

As depicted in FIG. 1, camera system 100 may also include an image sensor 110. Image sensor 110 may be a sensor that detects and conveys the information that constitutes an image. Light may flow through the lens 105 prior to being detected by image sensor 110 and be stored, for example, in memory 115. In one or more embodiments, the camera system 100 may include multiple lens systems 105A and 105B, and each of the lens systems may be associated with a different sensor element, or, as shown, one or more of the lens systems may share a sensor element 110.

Camera system 100 may also include an actuator 130, an orientation sensor 135 and mode select input 140. In one or more embodiments, actuator 130 may manage control of one or more of the lens assemblies 105. For example, the actuator 130 may control focus and aperture size. Orientation sensor 135 and mode select input 140 may supply input to control unit 145. In one embodiment, camera system may use a charged coupled device (or a complementary metal-oxide semiconductor as image sensor 110), an electro-mechanical unit (e.g., a voice coil motor) as actuator 130 and an accelerometer as orientation sensor 135.

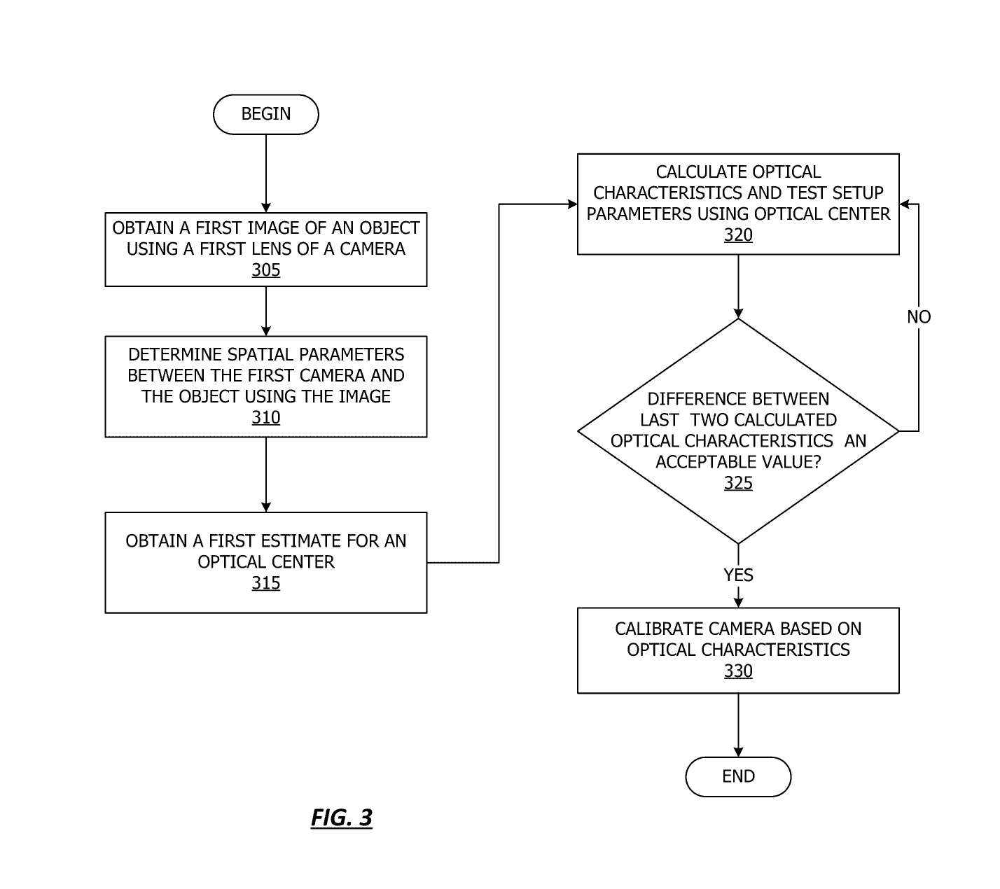

In one or more embodiments, some of the features of FIG. 3 may be repeated using a different test setup to obtain better optical characteristics and test setup parameters. For example, one or more additional charts 200 or other target objects may be used in calculating the best set of optical characteristics. For example, after optical characteristics and test setup parameters are calculated using a first test setup, then the best determined optical characteristics may be input into a second set of calculations using a second test setup to better refine the calculations.

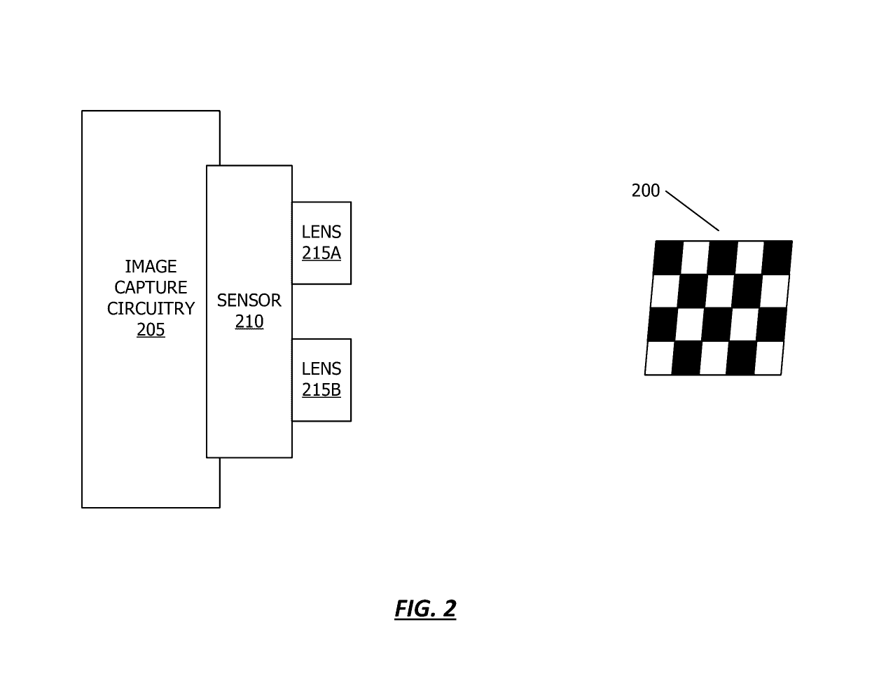

Turning to FIG. 2, an example block diagram is depicted indicating a type of camera system that may be calibrated according to one or more embodiments. In one or more embodiments, lens 215A and lens 215B may be independent lens assemblies, each having their own optical characteristics, that capture images of an object, such as object 200 in different ways. In one or more embodiments, image capture circuitry 205 may include two (or more) lens assemblies 215A and 215B. Each lens assembly may have different characteristics, such as a different focal length. Each lens assembly may have a separate associated sensor element 210. Alternatively, two or more lens assemblies may share a common sensor element.

Turning to FIG. 3, a method for determining optical characteristics, test setup parameters, and calibrating a camera is presented in the form of a flow chart. The method depicted in FIG. 3 is directed to calibrating a single camera. The flow chart begins at 305 where the first camera, such as that including lens assembly 215A captures an image of an object, such as object 200. In one or more embodiments, the camera may capture an image of any known target or other object for which the locations of the features on the target are known with some precision.

The flow chart continues at 310, and spatial parameters are determined between the first camera and the object based on the image. In one or more embodiments, the spatial parameters may include where the lens is focused, and the locations of various features of the object in the image. In one or more embodiments, some spatial characteristics may be estimated based on known quantities of the object in the image. For example, the geometric relationship between the object and the camera. The determined spatial parameters may be an initial guess of the spatial parameters based on what is previously known about the test setup.

The flow chart continues at 315, a first estimate of an optical center for the lens is obtained. In one or more embodiments, the first estimate of the optical center may be based, in part, on the determined spatial parameters. The initial guess for an optical center may be determined, for example, based on a center of the image, a center of the sensor, or by any other way. According to one or more embodiments, the first estimate of the optical center may be predetermined. For example, a center of the image may be selected as a first estimate of the optical center. As another example, a first estimate of the optical center may be predetermined based on characteristics of the camera or components of the camera, such as the lens or sensor.

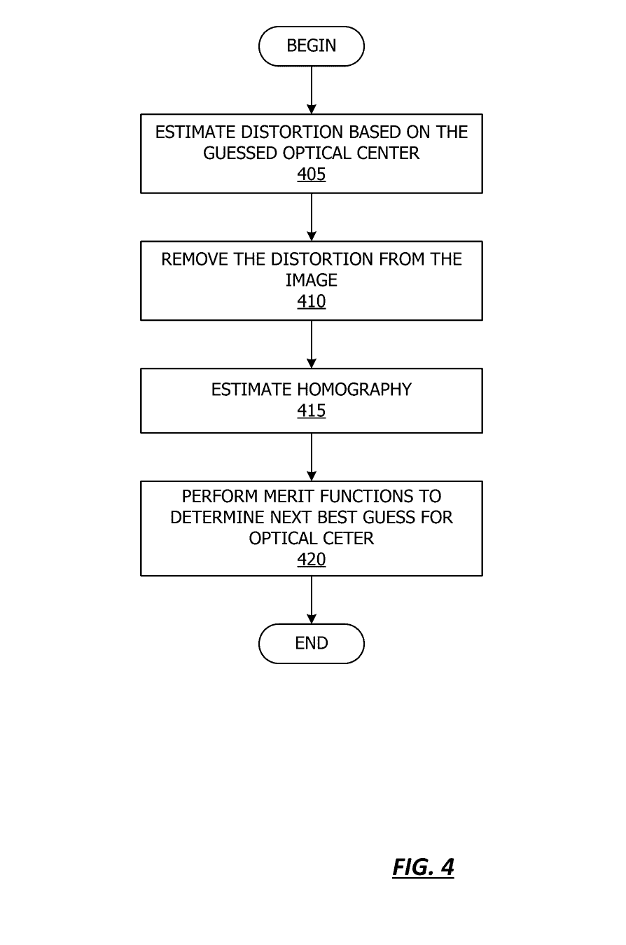

The flow chart continues at 315 and optical characteristics and test setup parameters are calculated. The calculated optical characteristics may include, for example, lens focal length, optical center, optical distortion, lateral chromatic aberration, distance between the object and the camera, object tilt angles, and object translation. In one or more embodiments, the various optical characteristics may be determined as a function of the optical center, such as the first estimate for the optical center. In one or more embodiments, determining the various optical characteristics and test setup parameters requires calculating for numerous variables. Thus, calculating the optical characteristics may involve a direct calculation, or an iterative calculation. The method for calculating the optical characteristics will be discussed in greater detail with respect to FIG. 4, below.

The flow chart continues at 325 and a determination is made regarding whether the difference between the last two calculated optical characteristics is an acceptable value. That is, when the difference between the estimated values in the last two rounds of calculations do not change much, we know that the estimations must be more precise. A determination is made regarding whether an acceptable level of precision has been reached. If at 325 it is determined that the difference between the last two calculated optical characteristics is not sufficiently small, then the flow chart returns to 320 and the next optical characteristics are calculated using a next best guess of the optical center, for example, until the difference between the last two calculated optical characteristics is sufficiently small.

If at 325 it is determined that the difference between the last two calculated optical characteristics is sufficiently small, then the flow chart continues. At 330, the camera may be calibrated based on the determined optical characteristics and test setup parameters. It should be understood that the various components of the flow chart described above may be performed in a different order or simultaneously, and some components may even be omitted in one or more embodiments.

Referring now to FIG. 4, an example flow chart is depicted of estimating optical characteristics of a camera system. Although the steps are depicted in a particular order, the various steps in the flowchart could occur in a different order. In addition, any of the various steps could be omitted, or other steps could be included, according to embodiments.

The flow chart begins at 405, and the distortion of the image is estimated based on a guessed optical center. In one or more embodiments, the optical center may be initially estimated as the center of the image, the center of the sensor, or calculated by taking a photo of a diffused light source and looking at illumination drop off. That is, the point in the image that appears the brightest may be estimated as the optical center. The optical center may be determined using other methods, such as determining a magnification center, distortion symmetry, or MTF symmetry. Based on the estimation for the optical center, distortion of the image is estimated to determine distortion coefficients. For example, the distortion may be estimated using a least squares estimate. The method continues at 410, and the distortion is removed from the image based on the estimate.

The flow chart continues at 415 and the homography is estimated based on the undistorted image (using the determined distortion coefficients) and the known object. Thus, the coefficients of the homography are determined based on the assumed distortion coefficients as determined in step 410 above. In one or more embodiments, the known features of the image are utilized to determine the differential between the object and the optical axis. In one or more embodiments, the tilt of the image is estimated and the features are mapped to determine the homography.

In one or more embodiments, the distortion and homography may be estimated simultaneously. According to one or more embodiments, the camera may conduct a focus sweep to capture images of one or more known charts. That is, the camera may captured images at various focal lengths. Based on an analysis of the images, the device may determine a distortion model which described the distortion as a function of image radius and focus position. Further, in one or more embodiments, the images captured in the focus sweep may also be used to estimate the homography, based on the determined distortion model.

Once the homgraphy is determined, the method continues at 420, and merit functions are performed to figure out what the next best guess of the optical center is. There are a number of merit functions that may be used to determine a next best guess for the optical center. In one or more embodiments, the various merit functions may be applied to obtain a better understanding of certain optical features, such as distortion curves, focal length, optical center, and properties of the lens such as chromatic aberration, and modulation transfer function.

As one example, the root means square metric may be used. In one or more embodiments, the root means square method may be used to determine how far off the undistorted, flat version of the image looks like compared to what the object should actually look like in the camera. As another example, a point line metric may be used to determine how accurate the optical center is in the image. Because optical distortion is, primarily, rotationally symmetric around the optical center, a point line metric can determine where the distortion in the image is centered, which should be a close estimate of the optical center. As another example, elbow room mean and variance allows for the features in the image to be mapped to a grid to determine how far off the modified image is compared to the grid. As another example, the linearity metric may be used to determine how straight the lines are. That is, an image captured through a lens may have some warping. For example, if there are features on an object in a straight line, they may be captured in an image with a curve. The linearity metric can be used to determine deviation away from an actual line. Further, in one or more embodiments, the various merit functions may be weighted.

According to one or more embodiments, any combination of the above identified merit functions may be applied to the image to determine a next best guess of the optical center. Because the various functions may rely on common variables, those variables may be refined over time. That is, in one or more embodiments, the extrinsic parameters of the camera may provide better inputs into an additional optimization. Further, in one or more embodiments, additional measurements may be additionally incorporated, which may act as constraints to the optimizations. As an example, measurements of the translation between two cameras via optical measuring microscopes or tilt angles measurement via methods employing collimators. Referring back to FIG. 3, once the next best guess of the optical center is calculated, a determination may be made regarding whether the optical center is accurate enough, or whether the image should be modified again and the merit functions should be applied again to an image based on a next best guess optical center.

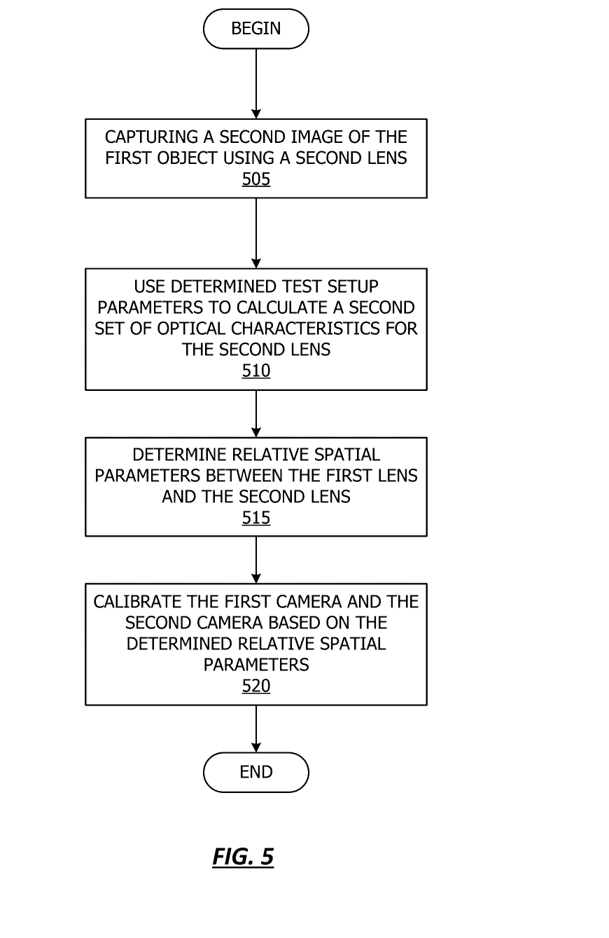

Turning to FIG. 5, an example method of multi-camera calibration. In one or more embodiments, once certain features of the image are known, such as the homography and how to remove the distortion, a very good guess may be made for how to calibrate the two cameras with respect to each other. Further, because the estimated locations of the features of the object have been identified with respect to the first camera that data may be taken into consideration when calibrating the second camera, and when calibrating the two cameras to each other.

The method of FIG. 5 begins at 505, wherein the second camera captures an image of the same first object. In one or more embodiments, the first camera and the second camera may be aligned along a similar plane. For purposes of multi-camera calibration, each camera may already be calibrated, for example using the methods described in FIG. 3-4. In order to calibrate the cameras, it may be necessary to determine relative rotation and relative translation between two cameras. In one or more embodiments, the first camera and the second camera may be part of a single camera system or portable electronic device, or may be two different devices.

The method continues at 510, and the determined homography information is used to determine the relative position of the multiple cameras. As described above, homography coefficients were previously determined during the calibration of each camera. Thus, the relative position of the object with respect to each lens may be used to determine the relative positions of the multiple cameras. Said another way, because during the intrinsic calibration of each individual camera, the relative orientation of the object was determined, then the relative orientations of the multiple cameras may be determined.

Once the distortion is determined and removed, the method continues at 515, and the locations in the first image are mapped to the locations in the second image. That is, because the locations of the features are known, and it is known that the first and second cameras are capturing images of the same object, then it may be determined how the particular feature in one camera compare to the locations of the features in the second image captured by the second camera. Thus, the individual pixels of the first image may be mapped to the individual pixels of the second image.

In one or more embodiments, the various features of FIG. 5 may be repeated using a different test setup. For example, a different chart or object of focus may be used. Further, the features may be repeated with the lenses of the multiple cameras focused at different distances in order to build a model of the multi-camera system's calibration as a function of focus. As another example, the features described above may be repeated at various temperatures such that a model may be built of the system's calibration with respect to temperature. As yet another example, the features described above may be repeated with various colors in order to build a model of the multi-camera system's calibration as a function of wavelength.

In one or more embodiments, the multi-camera system may also need to be recalibrated outside of a test setup, such as the test setup shown in FIG. 2. For example, in one or more embodiments, intrinsic or extrinsic calibration parameters in the multi-camera system may vary over time. As an example, internal springs may degrade over time, sensors may shift, lenses may shift, and other events may happen that cause variations in how the multi-camera system is calibrated over time. Further, the multi-camera system may need to be recalibrated in response to an acute event that affects camera calibration. For example, if the multi-camera system is part of an electronic device, and a user drops the electronic device, the intrinsic and/or extrinsic calibration parameters may be different than expected.

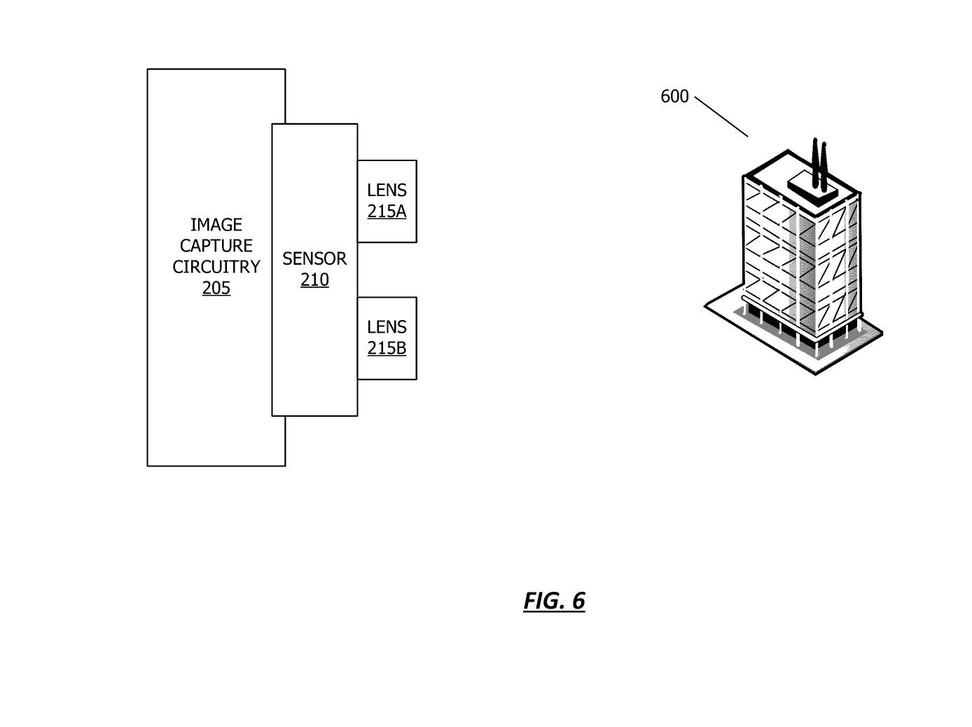

Turning to FIG. 6, the figure includes a multi-camera system that include image capture circuitry 205, one or more sensors 210, and two or more lens stacks 215A and 215B, as described above with respect to FIG. 2. However, in one or more embodiments, rather than requiring a known target, such as target 200, multi-camera calibration may be accomplished using images that the multi-camera system captures during the natural use of the device. As shown in FIG. 6, the multi-camera system may be recalibrated based on images captured of a day-to-day scene 600.

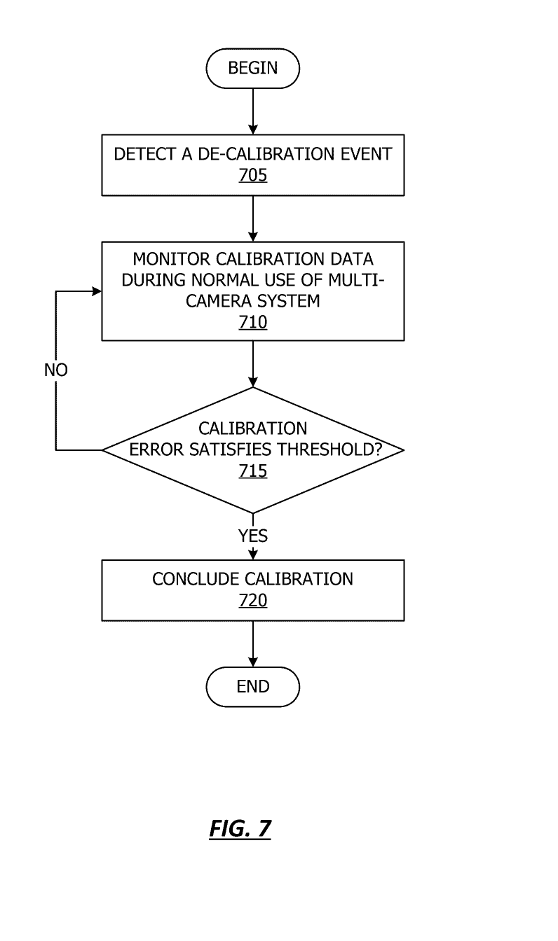

FIG. 7 shows, flow chart form, a multi-camera calibration method in accordance with one or more embodiments. Specifically, FIG. 7 shows how the multi-camera system may be calibrated in response to an acute de-calibration event, such as a drop of a device containing the multi-camera system. In one or more embodiments, the multi-camera calibration may provide adjusted intrinsic parameters, such as magnification, focal length, and optical center, as well as extrinsic parameters, or the physical alignment between two or more cameras in the multi-camera system.

The flow chart begins at 705, and a de-calibration event is detected. In one or more embodiments the de-calibration event may be any event that has an adverse effect on the calibration of the multi-camera system. The de-calibration event may be detected by one or more sensors of the multi-camera system. For example, the multi-camera system may include an accelerometer that may detect when a device is dropped. A drop may result in a sudden impact that has an adverse effect on the calibration of the multi-camera system, for example, because lenses could become slightly out of place, the sensor could shift, or the like. Further, over time, properties of the multi-camera system may change due to any number of factors.

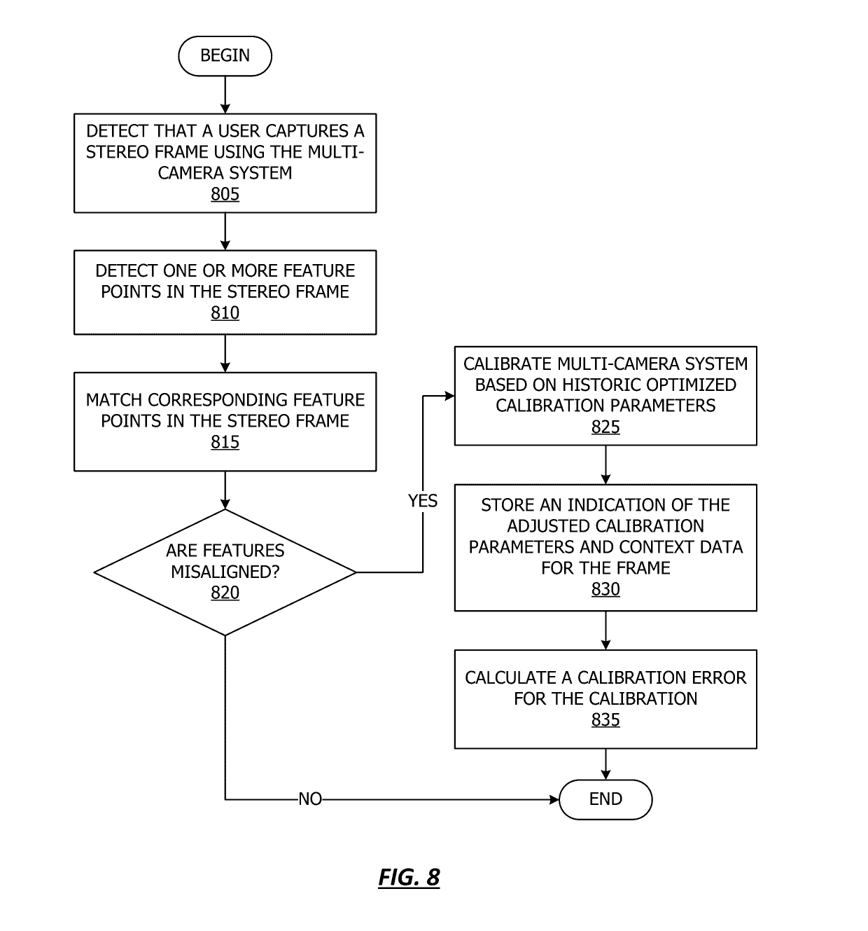

At 710, calibration data is monitored during normal use of the multi-camera system. In one or more embodiments, the recalibration may be tracked over time. The multi-camera system may be calibrated upon capturing each photo during the monitoring phase, as will be described below with respect to FIG. 8. Calibration data may be monitored for such data as lens distortion, intrinsic camera parameters, and extrinsic camera alignment.

AT 715, a determination is made regarding whether a calibration error satisfies a predetermined threshold. While the calibration data is monitored, a calibration error may be calculated. That is, a determination is made regarding whether the various intrinsic and extrinsic calibration parameters of the multi-camera system are optimized, or the error from one calibration to another requires a sufficiently small change that the calibration parameters are considered optimized. If it is determined that the calibration data does not satisfy the threshold, then the flow chart returns to 710 and the recalibration data continues to be tracked during normal use of the multi-camera system. The calibration data may be determined iteratively, for example, as a user captures various images with the multi-camera system.

If, at 715 it is determined that the calibration data is optimized, then at 720, the multi-camera system is considered sufficiently calibrated and the calibration is concluded. In one or more embodiments, intrinsic and/or extrinsic calibration parameters that resulted from the monitored calibration may become the new normal parameters when the multi-camera system captures more images in the future.

The process of monitoring calibration data may occur iteratively. In one or more embodiments, the calibration data may be monitored over time, for example, when a user of the multi-camera system captures future images. FIG. 8 shows, flow chart form, a multi-camera calibration method in accordance with one or more embodiments. More specifically, FIG. 8 depicts a particular iteration of the monitoring process shown in 710.

The flow chart begins at 805, and the system detects that a user has captured a frame using the multi-camera system. As described above with respect to FIG. 6, in one or more embodiments, the captured frame does not need to include a known target. Rather, the frame could be captured in the natural use of the multi-camera system. In one or more embodiments, a stereo frame is captured, which includes at least a first and second frame, corresponding to a first and second camera of the multi-camera system.

The flow chart continues at 810, and one or more feature points is detected in the frame. In one or more embodiments, each feature point may include a confidence value. Feature detection may be accomplished in any number of ways. Further, feature points that are detected may be associated with a confidence value, which may indicate a likelihood that the feature point provides a good match.

The flow chart continues at 815, and corresponding feature points in the first and second frames are matched. In one or more embodiments, matching feature points may include matching feature descriptors corresponding to the feature points. Further, in one or more embodiments, matching features in the first and second frame may also involve detecting outliers. In one or more embodiments, detecting outliers may prevent false matches.

At 820, a determination is made regarding whether the features are misaligned. The features may be determined to be misaligned, for example, if they are not aligned where they are expected to be. That is, for a given feature point in one image, an accurate calibration may be used to identify the epipolar line that contains the corresponding point in the second image. As another example, the feature points may be on the epipolar line, but may be in a wrong location. The position along the line of the matching feature point may be used to determine the physical distance to the point in 3D space. That is, the determined depth of the feature may be wrong.

Regarding depth, the calibration may address an incorrect depth determination. In one or more embodiments, incorrect depth information may be identified in a number of way. For example, if a captured image includes a picture of a face or other object for which a general size should be known, a scene understanding technique may be used. As another example, a distance range could be estimated. That is, no points in an image should be beyond infinity, so if points in the scene are determined to be past infinity, the depth in the scene is likely inaccurate. The distance range detection (and correction) method may also use a specified minimum distance point to detect error when points are identified at distances that are closer than the camera is expected to capture in focus. For example, if the points are sufficiently closer than the macro focus distance of the lens, such that objects would be too blurred to provide detectable feature points.

As another example, the multicamera system may include sensors that may be utilized to sense depth. Thus, the depth determined by the sensor may be compared to the depth determined based on the epipolar geometry of the frames. For example, an autofocus sensor may be used to determine depth based on the lens-maker's formula. The autofocus position sensor may provide an estimate of a single physical depth at which the camera is focused. Because the scene in the image may contain many depths, the region or regions of the image that are best in-focus first need to be determined (e.g. based on local image sharpness or information provided by the autofocus algorithm). Feature point pairs within the in-focus region(s) may be selected and depths estimated from their positions along the epipolar line using the calibration. The depth estimate from the autofocus sensor may then be compared to an estimate calculated from the feature point depth distribution (e.g. the median or mean) to evaluate if the discrepancy is above a threshold.

If the detected features are determined to be misaligned, then the flow chart continues at 825 and the intrinsic and/or extrinsic calibration parameters of the multi-camera system are calibrated. In one or more embodiments, the parameters may be calibrated, for example, by adjusting one or more sensors. The sensors may be directly adjusted to give new readings that would be tested on a future frame. In one or more embodiments, the sensors may be adjusted as part of an accumulated feedback loop.

Certain sensor readings may be used as the starting values for certain calibration parameters (e.g. APS for focal length, OIS sensor for optical center position). When there is calibration (e.g. perpendicular epipolar) error detected, the values are adjusted by the non-linear optimizer to reduce the calibration error metric. The set of sensor readings and the re-optimized adjusted values may be compared over time to detect systematic differences between them. For example, if there is offset or gain factor that the non-linear optimizer routinely applies to one or more sensor-derived parameters to lower the calibration error. Based on the pattern of parameter adjustment in the accumulated data, the sensor tuning (offset/scale) may then be adjusted to reduce the systematic differences between the initial sensor values and the parameter values produced by the non-linear optimizer. Further, a regression technique may detect that the pattern of error is correlated to the environmental context data stored. For example, the adjustment required for a certain sensor parameter may be found to increase as a function of temperature. The parameters may also be adjusted, for example, by adjusting a scale or magnification error, for example, by modifying a focal length in the calibration.

In one or more embodiments, calibrating the multi-camera system results in the feature points being properly aligned on the epipolar line. In one or more embodiments, calibrating the calibration parameters may involve running a non-linear optimizer over at least a portion of the calibration parameters.

In one or more embodiments, calibrating the calibration parameters involves at least two factors. First, corresponding feature points are realigned along the epipolar line. In one or more embodiments, the corresponding feature points may be determined to be some number of pixels off the epipolar line. Second, as described above, corresponding feature points may be associated with an incorrect depth. In one or more embodiments, the various detected feature points may be associated with confidence values. Only certain feature points may be considered for calibration based on their corresponding confidence values, according to one or more embodiments. For example, a confidence value of a feature point may be required to satisfy a threshold in order for the feature point to be used for the multi-camera system calibration. Further, feature points may be assigned weights and considered accordingly. That is, feature points with higher confidence values may be considered more prominently than feature points with lower confidence values.

In one or more embodiments, calibrating the multi-camera system may involve running a nonlinear optimizer based on at least a portion of the calibration parameters, as described above. The variables entered in to the nonlinear optimizer may be based, at least in part, on a detected difference between a location of the detected feature points and an expected location of the detected feature points.

In one or more embodiments, the quantitative perpendicular epipolar error can be estimated directly from natural image feature points pairs for use in a non-linear optimizer, but the parallel (depth) error may require targets at known depths to directly calculate quantitative error. In one embodiment, parameters for reducing parallel error may be adjusted using a range-based method. For example, range-base methods may include the use of accumulated/historic data on point positions along the epipolar line in conjunction with context data provided by the autofocus position sensor. With the range-based method, the detected positions of feature points along the epipolar line are compared with the infinity plane threshold point and one or more near plane distance points. The near plane threshold point may be selected to be at or below the minimum expected focus distance of the lens (macro focus of the lens). One or more calibration parameters may be iteratively updated to shift the calibrated distance scale to minimize the number of points (or weighted metric) that fall outside the range from the infinity to the specified near plane threshold.

In one or more embodiments, the data used for the range-based method may be accumulated over multiple frames to provide a distribution of feature points at different scene depths. The data selection may be based on the autofocus position sensor depth estimate, for example, to aid in selecting an image set with adequate feature point distance range, by choosing some images taken toward macro focus, which may likely contain near plane feature points, and some toward infinity focus, which may likely contain far plane feature points.

In one or more embodiments, the variables may be based on historic data for other entries in the context store with similar contexts to the current frame. For example, if the current frame was captured at a low temperature, then calibration data for previous images captured at a similar low temperature may be more successful than those determined at a higher temperature. As another example, if the current image was captured with the multi-camera system in an upright camera pose, then other previous calibration data for similar poses may be more beneficial than, for example, calibration data corresponding to images captured at a different pose, such as an upside-down pose of the multi-camera system. Further, a form of regression may be used on the previously estimated calibrations to predict or interpolate likely initializations of the parameters under new environmental factors, or as a Bayesian type framework for combination with the parameters estimated directly from new measurements. For example, if temperature data indicates a lower temperature than previously recorded as historic context data associated with adjusted parameters, then a pattern is determined based on previously recorded temperature data and the corresponding adjusted parameters such that a best first guess may be estimated.

Multiple regression techniques may also be used to detect and correct combinations of various environmental/sensor conditions that produce error. For example, the technique could detect that error in the focal length parameter occurs when there is a combination of high ambient temperature and the camera is positioned in a certain orientation (e.g. oriented such that the lens is being pulled downward by gravity).

Several parameters may be updated during recalibration. For example, individual intrinsic focal length parameters for the first and/or second camera may be adjusted, and/or a ratio thereof. Intrinsic principal point parameters for the first and/or second cameras may also be adjusted. Lens distortion parameters for the first and/or second camera, such as a center of distortion, or radial distortion polynomial parameters may also be adjusted. Extrinsic translation vector parameters for two or three degrees of freedom may be adjusted. Extrinsic rotation parameters may be adjusted.

The flow chart continues at 830, and an indication of the adjusted calibration parameters is stored along with context data for the frame at the time the frame is captured. For example, for the image pair, the resulting set of updated parameters may be stored in a context store, such as a buffer, along with other context data. In one or more embodiments, context data may include data regarding the multi-camera system at the time the stereo frame is captured. For example, the calibration store may also include data regarding environmental data, such as pressure or temperature data, auto focus sensor position, optical image stabilization (OIS) sensor position, and a pose of the multi-camera system. Other examples of context that may be stored include the feature point image coordinates in one of the images, such as the image determined to be the reference image, other candidate matching feature point image coordinates in the second image, confidence scores and determination data for the feature point pairs, date, time, autofocus sensor positions from either camera, OIS sensor position readings, other environmental data, or other camera system data.

In one or more embodiments, the candidate matching feature points and the context data may be stored in a circular storage buffer. When the storage buffer is full, data from the oldest captured images are replaced with data from recently captured images.

At 835, the multi-camera system may calculate a calibration error for the calibration. In one or more embodiments, the calibration error may indicate how much the various calibration parameters were adjusted. As described above with respect to FIG. 7, the calibration error may be used to determine whether or not the multi-camera system is sufficiently calibrated as to conclude the monitoring process. In one or more embodiments, the calibration error may be a weighted combination of the distances between the detected feature points in the secondary camera and the corresponding epipolar lines calculated from the model. For each feature point pair, a model may be used to calculate an epipolar line from a reference image coordinate. The set of distances may be weighted and combined into an overall error score. In addition, other metrics may be used when the absolute size of a scene object can be estimated or other size or distance information about the scene is available.

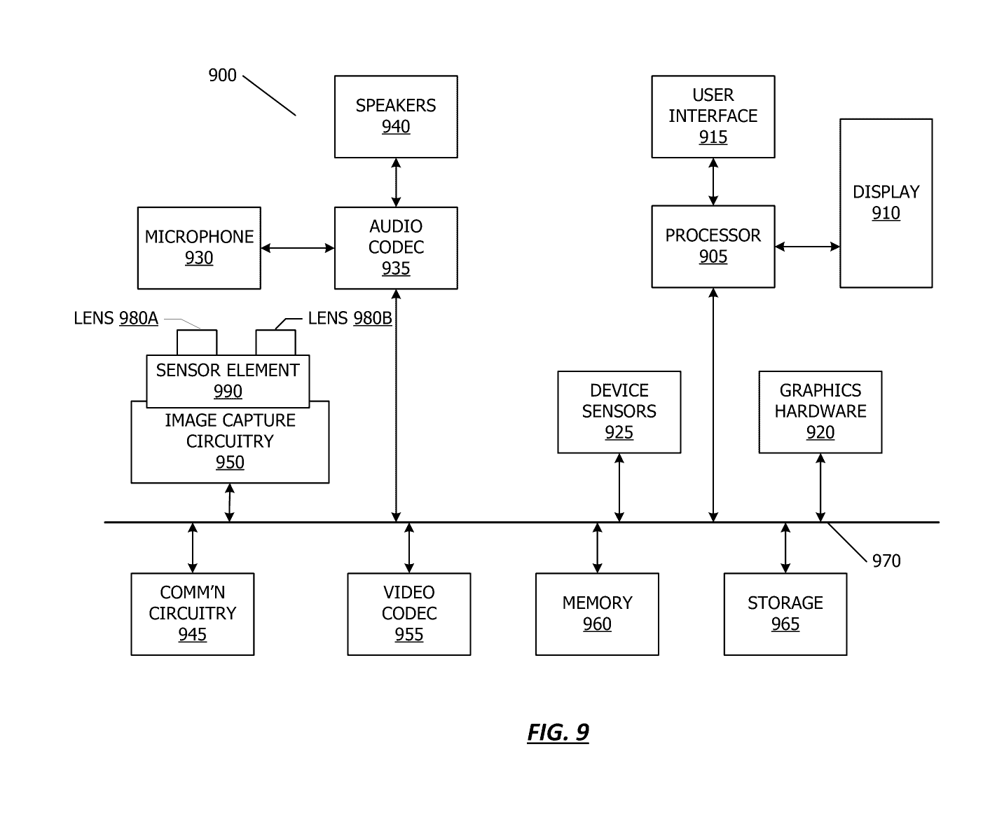

Referring now to FIG. 9, a simplified functional block diagram of illustrative multifunction device 900 is shown according to one embodiment. Multifunction electronic device 900 may include processor 905, display 910, user interface 915, graphics hardware 920, device sensors 925 (e.g., proximity sensor/ambient light sensor, accelerometer and/or gyroscope), microphone 930, audio codec(s) 935, speaker(s) 940, communications circuitry 945, digital image capture circuitry 950 (e.g., including camera system 100) video codec(s) 955 (e.g., in support of digital image capture unit 950), memory 960, storage device 965, and communications bus 970. Multifunction electronic device 900 may be, for example, a digital camera or a personal electronic device such as a personal digital assistant (PDA), personal music player, mobile telephone, or a tablet computer.

Processor 905 may execute instructions necessary to carry out or control the operation of many functions performed by device 900 (e.g., such as the generation and/or processing of images and single and multi-camera calibration as disclosed herein). Processor 905 may, for instance, drive display 910 and receive user input from user interface 915. User interface 915 may allow a user to interact with device 900. For example, user interface 915 can take a variety of forms, such as a button, keypad, dial, a click wheel, keyboard, display screen and/or a touch screen. Processor 905 may also, for example, be a system-on-chip such as those found in mobile devices and include a dedicated graphics processing unit (GPU). Processor 905 may be based on reduced instruction-set computer (RISC) or complex instruction-set computer (CISC) architectures or any other suitable architecture and may include one or more processing cores. Graphics hardware 920 may be special purpose computational hardware for processing graphics and/or assisting processor 905 to process graphics information. In one embodiment, graphics hardware 920 may include a programmable GPU.

Image capture circuitry 950 may include two (or more) lens assemblies 980A and 980B, where each lens assembly may have a separate focal length. For example, lens assembly 980A may have a short focal length relative to the focal length of lens assembly 980B. Each lens assembly may have a separate associated sensor element 990. Alternatively, two or more lens assemblies may share a common sensor element. Image capture circuitry 950 may capture still and/or video images. Output from image capture circuitry 950 may be processed, at least in part, by video codec(s) 965 and/or processor 905 and/or graphics hardware 920, and/or a dedicated image processing unit or pipeline incorporated within circuitry 965. Images so captured may be stored in memory 960 and/or storage 955.

Sensor and camera circuitry 950 may capture still and video images that may be processed in accordance with this disclosure, at least in part, by video codec(s) 955 and/or processor 905 and/or graphics hardware 920, and/or a dedicated image processing unit incorporated within circuitry 950. Images so captured may be stored in memory 960 and/or storage 965. Memory 960 may include one or more different types of media used by processor 905 and graphics hardware 920 to perform device functions. For example, memory 960 may include memory cache, read-only memory (ROM), and/or random access memory (RAM). Storage 965 may store media (e.g., audio, image and video files), computer program instructions or software, preference information, device profile information, and any other suitable data. Storage 965 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 960 and storage 965 may be used to tangibly retain computer program instructions or code organized into one or more modules and written in any desired computer programming language. When executed by, for example, processor 905 such computer program code may implement one or more of the methods described herein.

Although the disclosure generally discusses one or two cameras, the single and multi-camera calibration method described above may be used to calibrate any number of cameras. Because a related goal to solving stereo or multi-camera calibration involves understanding intrinsic parameters, the relative spatial parameters may also be determined, according to one or more embodiments. According to one or more embodiments, the multi-step process based on a function of the optical center may provide a more efficient means of camera calibration than solving for many variables at once. In one or more embodiments, the method for single and multi-camera calibration described above also allows for errors in test setup, such as an object that is not perfectly perpendicular to the lens optical axis. Estimating an individual camera's intrinsic parameters, such as focal length, optical center and optical distortion, may provide better inputs when determining relative orientation of two or more cameras. The relative rotation and translation parameters between two or more cameras and their optical axis translations may be better determined by considering the updated test setup parameters determined when determining the optical center for a single camera.

The following are examples pertaining to further embodiments.

Example 1 is a computer readable medium comprising computer readable code executable by a processor to: obtain a stereo frame captured by a multi-camera system, wherein the stereo frame comprises a first frame from a first camera and a second frame from a second camera; detect one or more feature points in the stereo frame; match a first feature point in the first frame with a corresponding feature point in the second frame; detect that the first feature point and the corresponding feature point are misaligned; calibrate, based on the detection, the multi-camera system based on a context of the multi-camera system at the time the stereo frame is captured, and one or more prior stored contexts, wherein each prior stored context is associated with prior adjusted calibration parameters; calculate a calibration error in response to the calibration; and conclude the calibration of the multi-camera system when the calibration error satisfies a threshold.

Example 2 is computer readable medium of Example 1, wherein the computer code is further configured to store, in a calibration store, an indication of a context of the multi-camera system and calibration data associated with the stereo frame.

Example 3 is the computer readable medium of Example 1, wherein the computer code to detect that the first feature point and corresponding feature point are misaligned comprises determining that the feature points are not aligned on an epipolar line.

Example 4 is the computer readable medium of Example 1, wherein the computer code to detect that the first feature point and corresponding feature point are misaligned comprises determining that the features are at an incorrect location along an epipolar line.

Example 5 is the computer readable medium of Example 1, wherein the context comprises one or more of environmental data, auto focus sensor position, OIS sensor position, and a pose of the multi-camera system.

Example 6 is the computer readable medium of Example 1, wherein the multi-camera system is calibrated in response to a detected event.

Example 7 is the computer readable medium of Example 6, wherein the event is detected by an accelerometer of the multi-camera system.

Example 8 is a system for camera calibration, comprising: a multi-camera system; one or more processors; and a memory coupled to the one or more processors and comprising computer code executable by the one or more processors to: obtain a stereo frame captured by the multi-camera system, wherein the stereo frame comprises a first frame from a first camera and a second frame from a second camera; detect one or more feature points in the stereo frame; match a first feature point in the first frame with a corresponding feature point in the second frame; detect that the first feature point and the corresponding feature point are misaligned; calibrate, based on the detection, the multi-camera system based on a context of the multi-camera system at the time the stereo frame is captured, and one or more prior stored contexts, wherein each prior stored context is associated with prior adjusted calibration parameters; calculate a calibration error in response to the calibration; and conclude the calibration of the multi-camera system when the calibration error satisfies a threshold.

Example 9 is the system of Example 8, wherein the computer code is further configured to store, in a calibration store, an indication of a context of the multi-camera system and calibration data associated with the stereo frame.

Example 10 is the system of Example 8, wherein the computer code to detect that the first feature point and corresponding feature point are misaligned comprises determining that the feature points are not aligned on an epipolar line.

Example 11 is the system of Example 8, wherein the computer code to detect that the first feature point and corresponding feature point are misaligned comprises determining that the features are at an incorrect location along an epipolar line.

Example 12 is the system of Example 8, wherein the context data for the multi-camera system at the time the frame was captured comprises one or more of environmental data, auto focus sensor position, OIS sensor position, and a pose of the multi-camera system.

Example 13 is the system of Example 8, wherein the multi-camera system is calibrated in response to a detected event.

Example 14 is the system of Example 13, wherein the event is detected by an accelerometer of the multi-camera system.

Example 15 is a method for camera calibration, comprising: obtaining a stereo frame captured by a multi-camera system, wherein the stereo frame comprises a first frame from a first camera and a second frame from a second camera; detecting one or more feature points in the stereo frame; matching a first feature point in the first frame with a corresponding feature point in the second frame; detecting that the first feature point and the corresponding feature point are misaligned; calibrating, based on the detection, the multi-camera system based on a context of the multi-camera system at the time the stereo frame is captured, and one or more prior stored contexts, wherein each prior stored context is associated with prior adjusted calibration parameters; and calculating a calibration error in response to the calibration; concluding the calibration of the multi-camera system when the calibration error satisfies a threshold.

Example 16 is the method of Example 15, further comprising storing, in a calibration store, an indication of a context of the multi-camera system and calibration data associated with the stereo frame.

Example 17 is the method of Example 15, wherein detecting that the first feature point and corresponding feature point are misaligned comprises determining that the feature points are not aligned on an epipolar line.

Example 18 is the method of Example 15, wherein detecting that the first feature point and corresponding feature point are misaligned comprises determining that the features are at an incorrect location along an epipolar line.

Example 19 is the method of Example 15, wherein the context data for the multi-camera system at the time the frame was captured comprises one or more of environmental data, auto focus sensor position, OIS sensor position, and a pose of the multi-camera system.

Example 20 is the method of Example 15, wherein the multi-camera system is calibrated in response to a detected event.

Example 21 is the method of Example 20, wherein the event is detected by an accelerometer of the multi-camera system.

The scope of the disclosed subject matter therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method for camera calibration, comprising:
capturing a first image of an object by a first camera;
determine spatial parameters between the first camera and the object using the first image;
obtain a first estimate for an optical center;
iteratively calculating a best set of optical characteristics and test setup parameters based on the first estimate for the optical center and the determined spatial parameters until the difference in a most recent calculated set of optical characteristics and previously calculated set of optical characteristics satisfies a predetermined threshold; and
calibrating the first camera based on the best set of optical characteristics.

2. The method of claim 1, wherein calculating a set of optical characteristics and test setup parameters based on the first estimate for the optical center comprises:
removing distortion from the first image,
estimating homography of the first image after the distortion has been removed, and
applying one or more merit functions to determine a best estimate optical center.

3. The method of claim 1, wherein further comprising:
capturing a second image of the object by a second camera;
calculating a second set of optical characteristics based on test setup parameters corresponding to the most recent calculated set of optical characteristics, the second set of optical characteristics comprising homography of the second image;
determining relative spatial parameters between the first camera and the second camera, and the object based on the first and second set of optical characteristics; and
calibrating the first camera and the second camera based on the determined relative spatial parameters.

4. The method of claim 3, wherein calculating a second set of optical characteristics based on test setup parameters comprises iteratively calculating the second set of optical characteristics until the difference in a most recent calculated second set of optical characteristics and previously calculated second set of optical characteristics satisfies a second predetermined threshold.

5. The method of claim 1, further comprising:
obtaining a second estimate of the optical center;
iteratively calculating a set of optical characteristics and test setup parameters based on the second estimate for the optical center until the difference in a most recent calculated set of optical characteristics and previously calculated set of optical characteristics satisfies a predetermined threshold; and
calibrating the first camera based on the most recent calculated set of optical characteristics.

6. The method of claim 1, further comprising:
determining an improved estimate of the optical center based on the best set of optical characteristics.

7. The method of claim 6, further comprising iteratively calculating an improved best set of optical characteristics and test setup parameters based on the improved estimate for the optical center until the difference in a most recent calculated set of optical characteristics and previously calculated set of optical characteristics satisfies a second predetermined threshold.

8. The method of claim 1, wherein the first estimate for the optical center is based on the determined spatial parameters.

9. The method of claim 3, further comprising:
obtaining a stereo frame captured by the first and second camera, wherein the stereo frame comprises a first frame from the first camera and a second frame from the second camera;
detecting one or more feature points in the stereo frame;
matching a first feature point in the first frame with a corresponding feature point in the second frame;
detecting that the first feature point and the corresponding feature point are misaligned;
calibrating, based on the detection, the first and second camera based on a context of the first and second camera at the time the stereo frame is captured, and one or more prior stored contexts, wherein each prior stored context is associated with prior adjusted calibration parameters;
calculating a calibration error in response to the calibration; and
concluding the calibration of the first and second camera when the calibration error satisfies a threshold.

10. The method of claim 9, wherein the computer code to detect that the first feature point and corresponding feature point are misaligned comprises detecting a depth error.

11. A system for camera calibration, comprising:
a memory operatively coupled to one or more digital image sensors and comprising computer code configured to cause one or more processors to:
capture a first image of an object by a first camera;
determine spatial parameters between the first camera and the object using the first image;
obtain a first estimate for an optical center;
iteratively calculate a best set of optical characteristics and test setup parameters based on the first estimate for the optical center and the determined spatial parameters until the difference in a most recent calculated set of optical characteristics and previously calculated set of optical characteristics satisfies a predetermined threshold; and
calibrate the first camera based on the best set of optical characteristics.

12. The system of claim 11, wherein the computer code configured to cause the one or more processors to calculate a set of optical characteristics and test setup parameters is further configured to cause the one or more processors to:
remove distortion from the first image,
estimate homography of the first image after the distortion has been removed, and
apply one or more merit functions to determine a best estimate optical center.

13. The system of claim 11, further comprising computer code configured to cause the one or more processors to:
capture a second image of the object by a second camera;
calculate a second set of optical characteristics based on test setup parameters corresponding to the most recent calculated set of optical characteristics, the second set of optical characteristics comprising homography of the second image;
determine relative spatial parameters between the first camera and the second camera, and the object based on the first and second set of optical characteristics; and
calibrate the first camera and the second camera based on the determined relative spatial parameters.

14. The system of claim 13, wherein the computer code configured to cause the one or more processors to calculate a set of optical characteristics and test setup parameters is further configured to cause the one or more processors to iteratively calculate the second set of optical characteristics until the difference in a most recent calculated second set of optical characteristics and previously calculated second set of optical characteristics satisfies a second predetermined threshold.

15. The system of claim 11, further comprising computer code configured to cause the one or more processors to:
obtain a second estimate of the optical center;
iteratively calculate a set of optical characteristics and test setup parameters based on the second estimate for the optical center until the difference in a most recent calculated set of optical characteristics and previously calculated set of optical characteristics satisfies a predetermined threshold; and
calibrate the first camera based on the most recent calculated set of optical characteristics.

16. The system of claim 11, further comprising computer code configured to cause the one or more processors to:
determine an improved estimate of the optical center based on the best set of optical characteristics.

17. The system of claim 16, further comprising computer code configured to cause the one or more processors to:
iteratively calculate an improved best set of optical characteristics and test setup parameters based on the improved estimate for the optical center until the difference in a most recent calculated set of optical characteristics and previously calculated set of optical characteristics satisfies a second predetermined threshold.

18. A computer readable medium comprising computer code for camera calibration, the computer code executable by one or more processors to:
capture a first image of an object by a first camera;
determine spatial parameters between the first camera and the object using the first image;
obtain a first estimate for an optical center;
iteratively calculate a best set of optical characteristics and test setup parameters based on the first estimate for the optical center and the determined spatial parameters until the difference in a most recent calculated set of optical characteristics and previously calculated set of optical characteristics satisfies a predetermined threshold; and
calibrate the first camera based on the best set of optical characteristics.

19. The computer readable medium of claim 18, the computer code further executable by one or more processors to:
remove distortion from the first image,
estimate homography of the first image after the distortion has been removed, and
apply one or more merit functions to determine a best estimate optical center.

20. The computer readable medium of claim 18, the computer code further executable by one or more processors to:
capture a second image of the object by a second camera;
calculate a second set of optical characteristics based on test setup parameters corresponding to the most recent calculated set of optical characteristics, the second set of optical characteristics comprising homography of the second image;
determine relative spatial parameters between the first camera and the second camera, and the object based on the first and second set of optical characteristics; and
calibrate the first camera and the second camera based on the determined relative spatial parameters.

21. The computer readable medium of claim 20, wherein the computer code executable by one or more processors to calculate a set of optical characteristics and test setup parameters is further executable by the one or more processors to iteratively calculate the second set of optical characteristics until the difference in a most recent calculated second set of optical characteristics and previously calculated second set of optical characteristics satisfies a second predetermined threshold.

22. The computer readable medium of claim 19, further comprising computer code configured to cause the one or more processors to:
obtain a second estimate of the optical center;
iteratively calculate a set of optical characteristics and test setup parameters based on the second estimate for the optical center until the difference in a most recent calculated set of optical characteristics and previously calculated set of optical characteristics satisfies a predetermined threshold; and
calibrate the first camera based on the most recent calculated set of optical characteristics.

23. The computer readable medium of claim 18, further comprising computer code configured to cause the one or more processors to:
determine an improved estimate of the optical center based on the best set of optical characteristics.

24. The computer readable medium of claim 23, further comprising computer code configured to cause the one or more processors to:
iteratively calculate an improved best set of optical characteristics and test setup parameters based on the improved estimate for the optical center until the difference in a most recent calculated set of optical characteristics and previously calculated set of optical characteristics satisfies a second predetermined threshold.
